(19) United States
(12) Patent Application Publication
(10) Pub. No.: US 2009/0132427 A1
(43) Pub. Date: May 21, 2009

(54) METHODS AND SYSTEMS FOR PROVIDING MULTIPLE REAL ESTATE OFFERS

(76) Inventor: D. Lorenzo MATTHEWS, SR., Huntersville, NC (US)

Correspondence Address: Clements Bernard PLLC, 1901 Roxborough Road, Suite 300, Charlotte, NC, 28211, US

(21) Appl. No.: 12/274,246

(22) Filed: Nov. 19, 2008

Related U.S. Application Data
(60) Provisional application No. 60/989,049, filed on Nov. 19, 2007.

(51) Int. Cl. G06Q 40/00; G06Q 50/00

(52) U.S. Cl. 705/80; 705/38; 705/37

(57) ABSTRACT

The present disclosure is a real estate offer system and method for providing multiple offers to buy a property for a buyer. The present invention can be implemented through a Web site or the like. The systems and methods are utilized by realtors, real estate investors, and the like to improve the process of buying properties.

### CROSS-REFERENCE TO RELATED APPLICATION(S)

The present non-provisional application claims priority to U.S. Provisional Patent Application No. 60/989,049 filed Nov. 19, 2007 and entitled “METHODS AND SYSTEMS FOR PROVIDING MULTIPLE REAL ESTATE OFFERS,” the contents of which are herein incorporated by reference.

### FIELD OF THE INVENTION

The present invention relates generally to real estate purchases. More particularly, the present invention provides methods and systems for providing multiple real estate offers through an integrated computer application.

### BACKGROUND OF THE INVENTION

Real estate has always been the key stone for financial and economic growth. Two axioms that have proven constant are: 1. Land is the one thing they're not making any more of, and 2. everyone has to have a place to live. Even though great fortunes have been made through industry and technology, real estate is always the depository of that wealth. And as the economy grows, the stock market goes up and inflation steadily pushes prices ahead, real estate continues to increase in price and investors continue to look for deals.

There are many products for real estate investors on the market that compete against each other to “show how it's done” and some even mention making multiple offers but none have a unique system and method of the present invention to quickly compute the numbers required to successfully make accurate offers.

### BRIEF SUMMARY OF THE INVENTION

In various exemplary embodiments, the present invention is a real estate offer system and method for providing multiple offers to buy a property for a buyer. The present invention can be implemented through a Web site or the like. The systems and methods are utilized by realtors, real estate investors, and the like to improve the process of buying properties.

In an exemplary embodiment, a computer-executable method for providing multiple offers from a buyer to a seller includes determining a maximum allowable offer; determining an interest rate; determining a plurality of time periods; calculating multiple offers based on the plurality of time periods from the maximum allowable offer, the interest rate; and displaying the multiple offers. The computer-executable method further includes determining whether the seller owes more than the maximum allowable offer for a property or substantially the same as the maximum allowable offer; if the seller owes more than the maximum allowable offer, performing one of watching the property and performing a short sale on the property; and if the seller owes substantially the same as the maximum allowable offer, taking over the property from the seller. The calculating multiple offers includes performing one of calculating a monthly payment calculation and inputting a monthly payment to the seller; and calculating seller retained equity as a difference of the maximum allowable offer and a cash offer amount. The calculating a monthly payment calculation includes computing the monthly payment from sellers retained equity and the interest rate over a predetermined time period. The multiple offers include any of a cash offer and a payment plan over the plurality of time periods with a balloon payment. The computer-executable method can be executed on a computer server connected to a network or as a stand-alone program on one of a computer system, a cell phone, and a personal digital assistant.

In another exemplary embodiment, a system for computing multiple offers from a buyer to a seller includes a data store; memory; a network interface connected to a network; input/output interfaces; a processor; a local interface communicatively coupling the data store, the memory, the network interface, the input/output interfaces, and the processor; wherein the processor is configured to perform the steps of: determining a maximum allowable offer; determining an interest rate; determining a plurality of time periods; calculating multiple offers based on the plurality of time periods from the maximum allowable offer, the interest rate; and displaying the multiple offers. The processor is further configured to perform the steps of: determining whether the seller owes more than the maximum allowable offer for a property or substantially the same as the maximum allowable offer; if the seller owes more than the maximum allowable offer, performing one of watching the property and performing a short sale on the property; and if the seller owes substantially the same as the maximum allowable offer, taking over the property from the seller. The processor is further configured to perform the steps of: performing one of calculating a monthly payment calculation and inputting a monthly payment to the seller; and calculating seller retained equity as a difference of the maximum allowable offer and a cash offer amount. Optionally, the processor is configured to perform the steps of: computing the monthly payment from sellers retained equity and the interest rate over a predetermined time period. The multiple offers include any of a cash offer and a payment plan over the plurality of time periods with a balloon payment.

In yet another exemplary embodiment, a computer system includes means for receiving input and providing output to a plurality of users including buyers and sellers; means for calculating multiple offers for a purchase from a buyer to a seller; means for customizing the multiple offers based of a plurality of variables; an Offer Negotiating System; a Forms System; a Mortgage Short Sale System; and an Auto Watch and Re-submittal marketing page. The computer system further includes means for displaying real estate.

### BRIEF DESCRIPTION OF THE DRAWINGS

The present invention is illustrated and described herein with reference to the various drawings, in which like reference numbers denote like method steps and/or system components, respectively, and in which:

FIG. 1 illustrates a flowchart of a Multiple Offer Calculator (hereinafter referred to as “MOC1”) according to an exemplary embodiment of the present invention;

FIG. 2 illustrates a flowchart of a MOC1 offer mechanism for providing multiple offers from a buyer/investor to a seller according to an exemplary embodiment of the present invention;

FIG. 3 illustrates a flowchart of a MOC1 payment calculation mechanism according to an exemplary embodiment of the present invention;

FIGS. 4 through 9 illustrate various flowcharts of a monthly payment offer calculation according to an exemplary embodiment of the present invention;

FIG. 10 illustrates a flowchart of a final calculation of the multiple offers according to an exemplary embodiment of the present invention;

FIGS. 11 and 12 illustrate example screen views of a multiple offer system according to an exemplary embodiment of the present invention; and

FIG. 13 illustrates a block diagram of a server for executing a multiple offer system according to an exemplary embodiment of the present invention.

### DETAILED DESCRIPTION OF THE INVENTION

In various exemplary embodiments, the present invention is a real estate offer system and method for providing multiple offers to buy a property for a buyer. The present invention can be implemented through a Web site or the like. The systems and methods are utilized by realtors, real estate investors, and the like to improve the process of buying properties.

The present invention provides its customers with the tools needed to successfully invest in real estate. Other than short sales and foreclosures, the only tool that a real estate investor has to get the price down to an acceptable level is to manipulate the seller's equity in some way. When analyzing a property, the investor determines the after repaired value (ARV) and gets an estimate of the cost of repairs (COR) to get the property to that acceptable purchase price. The generally accepted buy point or maximum allowable offer (MAO) is 70% of the ARV minus COR. Of course, an additional 5% to 10% is built in to allow the investor to wholesale the property and actually make something on the deal. Once mortgages and other encumbrances are deducted from this buying point, the investor then negotiates this remaining equity with the seller. But the seller then looks at this investor offer and their first reaction is a combination of surprise, hurt, anger, insult, abuse, misuse and outrage. They immediately become offended and the investor backs off a bit. The seller then responds by trying to take advantage and the result is a back and forth negotiation process that many liken to a dance. A dance though, that leaves the investor shuffling endlessly around the issues while resentment builds on both sides.

The present invention allows the investor to take the lead in the dance with multiple equivalent simultaneous offers, or MESOs. Presenting more than one offer at a time increases the other side's satisfaction as well as the odds that an agreement can be implemented. Research shows that negotiators who use MESOs achieve better outcomes than those who make a single packaged offer, without sacrificing relationships or losing credibility.

The National Association of Realtors (NAR) boasts members to date as of July 2007, month end to be 1,363.493 with the number of local associations at 1,443. In our opinion, the average realtor does little to creatively help with the negotiations of the RE sale. Using the present system allows realtors to actively work out more deals and complete more sales, at higher prices, garnishing higher commissions than ever before.

Most real estate transactions deal with residential property but land and commercial deals usually have a larger amount of seller equity and the present invention can provide even more value in these circumstances.

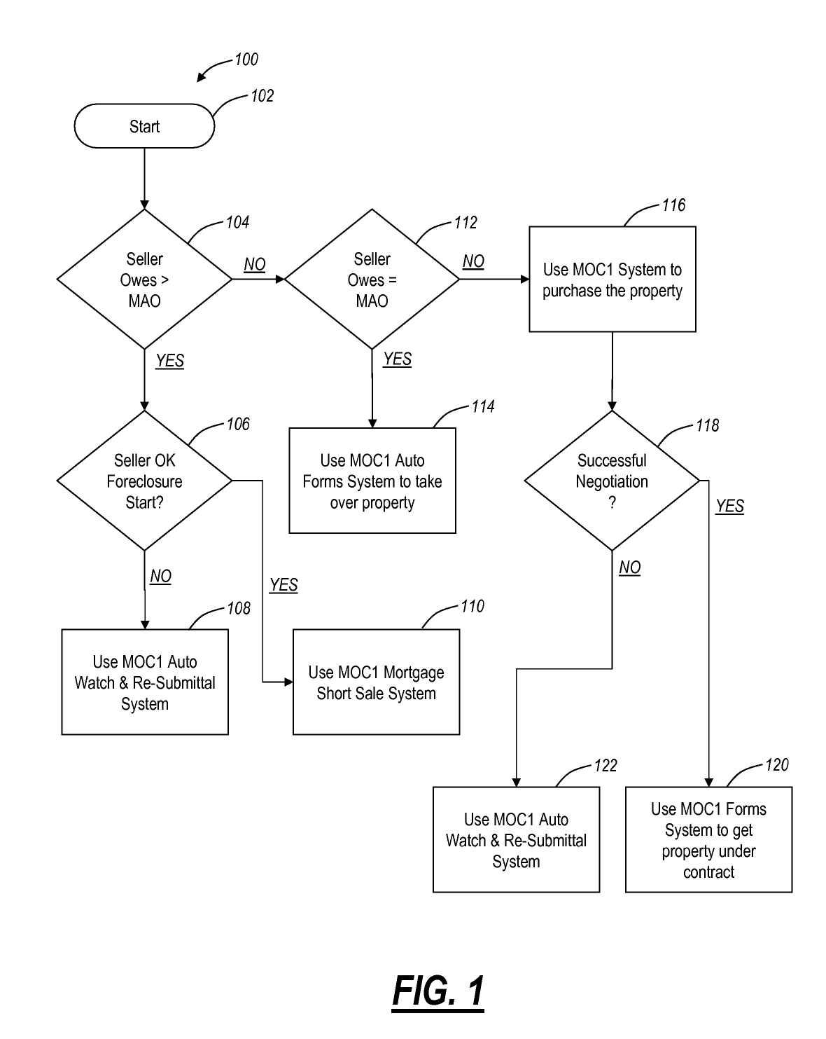

Referring to FIG. 1, a flowchart illustrates a Multiple Offer Calculator (hereinafter referred to as “MOC1”) 100 according to an exemplary embodiment of the present invention. The MOC1 is a system for creating multiple offers to sellers. It shows the seller various alternatives to payment in all cash to get what they want, while still allowing the investor/buyer to buy the property at an acceptable price. The system can be a stand-alone software tool or a web-based application.

MOC1 can include various components including: 1. The MOC1 Offer Negotiating System, 2. The MOC1 Forms System, 3. The MOC1 Mortgage Short Sale System, and 4. The MOC1 Auto Watch & Re-submittal System. Additionally, the MOC1 can include investor tools, real estate forms, GURU Evaluations, RE News, and RE products for sale. The investor tools can include many useful items for investors like setting up eMail scripts & autoresponders, links to useful sites and other tools and tips we can glean from available sources. The information is categorized so that by looking for a particular topic, they can read any information and get any tools related to the topic.

The RE forms can include hundreds of real estate and legal forms that can be printed but not downloaded or saved to the client's computer. The variables are input through a numbered table format with brief explanations. The forms are stored in the client's database located on a server server. As long as the client maintains their subscription, they can be allowed to retrieve old forms to revise or change them for new transactions, continuously creating new ones.

The GURU evaluations can include evaluations of the many Real Estate (RE) gurus packages and products for sale. These provide evaluations of the many packages with opinions on each. The RE News can provide each subscriber a profile that includes their location. They can have an option of going to a section on the latest RE related news in their area, state or nationwide. The present invention also tracks things like the current interest rates for the prime rate, the FHA rates, different categories of lending, etc. The present invention also shows graphs of the changes in these rates and predictions for investor perspectives. There can also be the option of getting this info through pop ups on their desktops. Finally, the present invention can include RE products for sale, i.e., property listings and the like. The present invention gives subscribers at their fingertips, things they would have to go to many other sources to find and then have to pay ten to fifty times their monthly subscription fee to purchase.

The MOC1 100 system for realtors can educate them on how negotiating on behalf of their buyers to result in more open negotiations, greater buyer and seller satisfaction, more accepted offers and larger offers, and more frequent commissions. Buyer's agents can position themselves as dual agents who can demand a flat fee or percentage commission from the buyer by touting their ability to help the buyer find the home they want and then get it for less, while at the same time be able to garnish the buyer's agent portion of the sale. On the other hand, listing agents will be able to assist sellers by showing them ways to get the price they are seeking by being more flexible with the terms, or show them ways to make the deal more profitable by less conventional structuring and advertising of the property. Agents can profitably list properties that other agents without the MOC1 could not find a way to assist the seller. The system would be of even greater value to commercial realtors since it helps structure the terms around the owner's equity. Most sellers of commercial properties have large amounts of equity and are usually motivated enough to be well-disposed to negotiations well-disposed their equity.

These same arguments will be used with investors because they can use all of these tools and techniques to assist in their own deals and structure them around their bottom line while opening other alternatives to the seller. When selling properties with equity in them, investors can make properties more desirable to the buyers while maintaining interest in the property and greatly reducing the liability.

FIG. 1 illustrates the MOC1 100 for preparing multiple real estate offers from a buyer/investor to a seller. The MOC1 100 starts (step 102) and first determines whether a seller owes more than the MAO (step 104). If the seller does owe more than the MAO, then the seller is potentially in foreclosure (step 106). Here, the buyer/investor can use the MOC1 Auto Watch and Re-submittal system (step 108) if the seller is not yet ready to go into foreclosure, or use the MOC1 Mortgage short sale system (step 110) if the seller is okay with foreclosure.

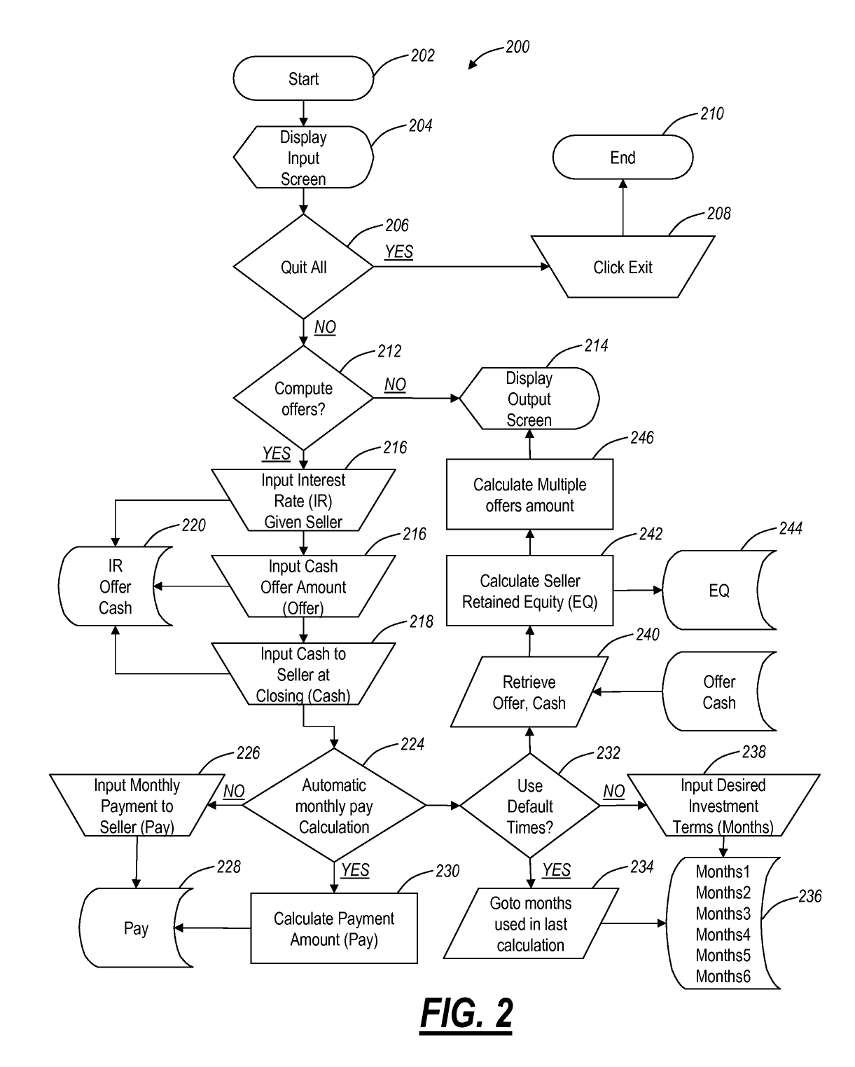

If the seller owes the MOA (step 112), then the buyer/investor can use the MOC1 Auto Forms system to take over the property (step 114). If the seller owes less than the MOA (step 112), then the buyer/investor can use the MOC1 system to purchase the property (step 116) by providing a variety of inputs to obtain multiple offers to present to the seller. The details of the MOC1 system are described herein with reference to FIGS. 2 through 10.

If the negotiation is successful (step 118) following the multiple offers, then the buyer/investor can use the MOC1 forms system to get the property under contract (step 120). If the negotiation is not successful (step 118), then the buyer/investor can user the MOC1 Auto Watch and Re-submittal system (step 122).

Referring to FIG. 2, a flowchart illustrates a MOC1 offer mechanism 200 for providing multiple offers from a buyer/investor to a seller according to an exemplary embodiment of the present invention. The MOC1 offer mechanism 200 starts (step) 202) by displaying an input screen to the buyer/investor (step 204). For example, the input screen can be a graphical user interface (GUI). From the input screen, the buyer/investor can select quit all (step 206) clicking exit (step 208) and ending the offer mechanism 200 (step 210).

From the input screen, the buyer/investor can determine whether to compute offers (step 212). If not, the MOC1 offer mechanism 200 can display an output screen (step 214). The output screen can include previously computed offers and the like. If the buyer/investor wants to compute offers, then a plurality of inputs are provided to the MOC1 offer mechanism 200 (steps 216, 218, 220) and each input is stored (step 222).

The plurality of inputs include:

(01) Interest Rate (IR)
(02) cash Offer amount (Offer)
(03) Cash given to seller at closing (Cash)

Next, the buyer/investor decides whether to compute an automatic monthly pay calculation (step 224). If not, the buyer/investor inputs a monthly payment (pay) to the seller (step 226) and this is stored as “pay” (step 228). If so, the MOC1 offer mechanism 200 automatically calculates the payment amount (step 230) and this is stored as “pay” (step 232). The payment amount includes a monthly payment computed from sellers equity and the input interest rate over 30 years.

After step 224, the buyer/investor decides whether or not to use default time periods (step 232). If so, the MOC1 offer mechanism 200 goes to the months used in the last calculation (step 234) and stores these values as months1, months2, months3, months4, months5, and months6 (step 236). If not, the buyer/investors inputs desired investment terms in months (step 238), and this is stored as months1, months2, months3, months4, months5, and months6 (step 236).

Collectively, these stored values include optional inputs as follows:

(04) monthly payment to be made on seller equity (Pay)
(05) first time frame for the proposed period of seller financing (Months 1)
(06) second time frame for the proposed period of seller financing
(Months 2)
(07) third time frame for the proposed period of seller financing
(Months 3)
(08) fourth time frame for the proposed period of seller financing
(Months 4)
(09) fifth time frame for the proposed period of seller financing
(Months 5)
10) sixth time frame for the proposed period of seller financing (Months 6)

The default monthly payment (Pay) is computed automatically using the Sellers Equity (EQ) and the Input Interest Rate (IR), over a 30 year or 360 month period (Term). Note that if PAY is input manually, the resultant offer amount will be greater in proportion to the input PAY when PAY is less than the default PAY. Conversely, the offer will be less when PAY is greater than the default PAY. The Input Interest Rate (IR) is divided by 12 to give the monthly interest rate (IM) by using the equation.

The default monthly payment (Pay) is computed automatically using the Sellers Equity (EQ) and the Input Interest Rate (IR), over a 30 year or 360 month period (Term). Note that if PAY is input manually, the resultant offer amount will be greater in proportion to the input PAY when PAY is less than the default PAY. This can be used in Conversely, the offer will be less when PAY is greater than the default PAY. The Input Interest Rate (IR) is divided by 12 to give the monthly interest rate (IM) by using the equation,

$$\begin{matrix}Pay = ( EQ * IM ) / ( 1 - {( 1 + IM )}^{⋀} - 360 ) or \\ Pay = \frac{EQ * IM}{1 - {( 1 + IM )}^{- 360}}\end{matrix}$$

### Where,

Pay→Monthly payment made to the seller, paid in arrears
EQ→The seller's retained equity in the property. This is calculated by subtracting the Cash given to seller at closing from the cash offer amount (Offer), i.e. EQ=Offer−Cash
IM→The monthly interest rate. This is calculated by dividing the input interest rate (IR) by 12, or IR/12.
   The initial/default time frames used are shown below:

| Investment Periods (months) | Investment Periods (years) |
|---|---|
| 36 | 3 |
| 84 | 7 |
| 144 | 12 |
| 216 | 18 |
| 288 | 24 |
| 360 | 30 |

After step 232, the MOC1 offer mechanism 200 retrieves the offer and cash amounts (step 240). Next, the MOC1 offer mechanism 200 calculates seller retained equity (EQ) (step 242) and stores this value (step 244). The EQ equals The MOC1 offer mechanism 200 then computes multiple offer amounts based upon the various variables (step 246). The output screen displays an output of the IR, Offer, Cash, Pay, EQ, Offer1, Offer2, Offer3, Offer4, Offer5, and Offer6 (step 214).

The Offer1, Offer2, Offer3, Offer4, Offer5, and Offer6 are “alternative to all cash” offers which can be presented to the seller. Each of the “Alternative to All Cash” offers is computed by adding the three (3) components below:

1. The amount of equity (EQ) not paid during the term agreed upon with the seller. This balance is also referred to as the Balloon Payment and is computed manually by subtracting the total amount paid toward the principle or EQ during the investment period.

2. The total amount of the payments (Pay) made during the investment period. This is derived by multiplying the monthly payment by the number of months of the investment period or Pay * Months.

3. The initial cash payment (Cash) given to the seller at closing.

### EXAMPLE

The following is an example of a set of multiple offers computed with the following criteria:

| User Input Values | Value |
|---|---|
| Interest Rate (IR) | 7.110% |
| Cash Offer Amount (Offer) | $55,000.00 |
| Cash given to seller at | $10,000.00 |
| closing (Cash) | |
| Monthly Interest Rate (IM) | 0.5925% (note 1) |
| Sellers Equity (EQ) | $45,000.00 (note 2) |
| Monthly payment (Pay) | $302.717873 (note 3) |
| First time frame (Months1) | 36 Months |
| Second time frame (Months2) | 84 Months |
| Third time frame (Months3) | 144 Months |
| Fourth time frame (Months4) | 216 Months |
| Fifth time frame (Months5) | 288 Months |
| Sixth time frame (Months6) | 360 Months |

Note 1-
$IM = \frac{IR}{12} = \frac{7.11 \%}{12} = 0.5925 \%$
Note 2-
EQ = Offer - Cash = $55,000.00- $10,000.00
Note 3-
$\begin{matrix}Pay = \frac{EQ * IM}{1 - {( 1 + IM )}^{- 360}} \\ = \frac{\$ 45 , 000.00 * 0.5925 \%}{1 - {( 1 + 0.5925 \% )}^{- 360}} \\ = \$302 .717873\end{matrix}$

The program then computes the balance of the seller's equity (EQ) i.e. Balloon Payment after payments are made for each of the monthly periods that the seller can choose from. The results of the monthly payment calculations are shown in the table below, with an excerpt of the pertinent lines below and a screen shot of the program results below that:

| Months | PV | Payment | Interest | Principle |
|---|---|---|---|---|
| 36 | 43556.42 | 302.7179 | 258.07 | 44.65 |
| 84 | 41086.01 | 302.7179 | 243.43 | 59.28 |
| 144 | 36829.65 | 302.7179 | 218.22 | 84.50 |
| 216 | 29269.20 | 302.7179 | 173.42 | 129.30 |
| 288 | 17700.86 | 302.7179 | 104.88 | 197.84 |
| 360 | 0.00 | | | |

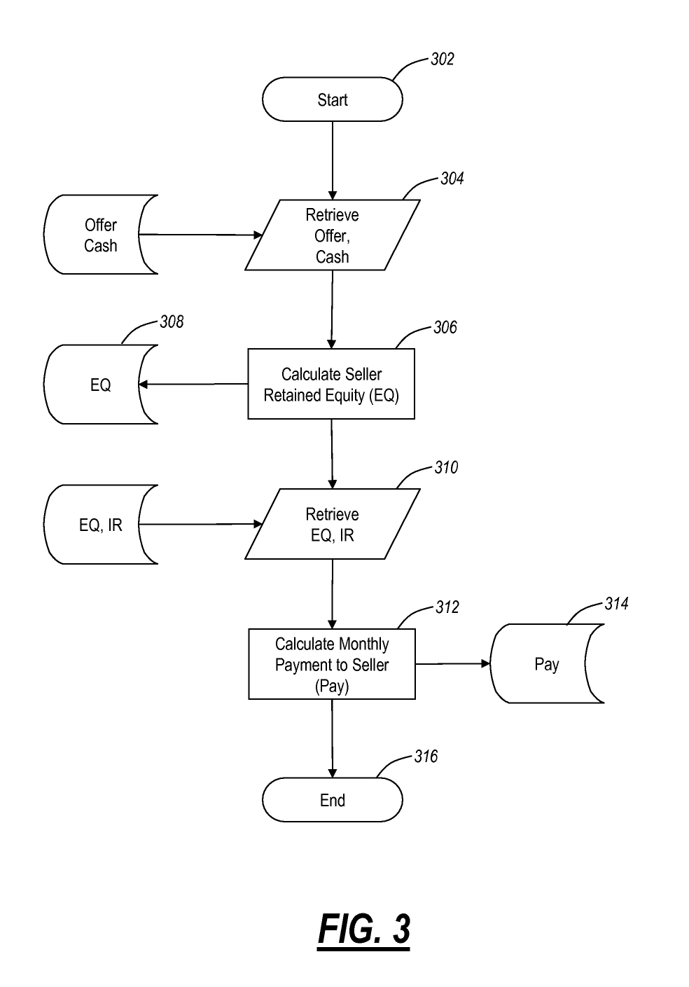

Referring to FIG. 3, a flowchart illustrates a MOC1 payment calculation mechanism 300 according to an exemplary embodiment of the present invention. The MOC1 payment calculation mechanism 300 starts (step 302) by retrieving the Offer and Cash amounts (step 304). The MOC1 payment calculation mechanism 300 calculates the seller retained equity (EQ) (step 306) and stores it (step 308). The MOC1 payment calculation mechanism 300 retrieves EQ and IR (step 310) to calculate the monthly payment to the seller (Pay) (step 312). The pay amount is stored (step 314), and the MOC1 payment calculation mechanism 300 ends (step 316).

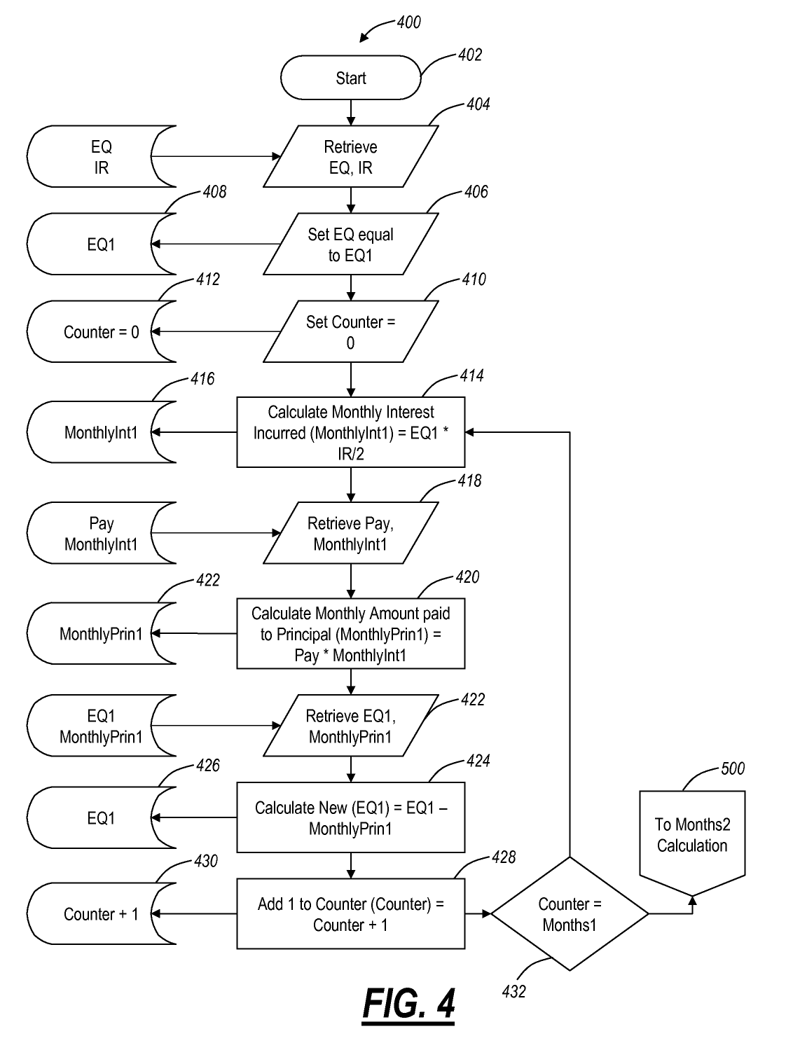

Referring to FIGS. 4 through 9, various flowcharts illustrate a monthly payment offer calculation 400 according to an exemplary embodiment of the present invention. The monthly payment offer calculation 400 provides a mechanism to calculate multiple offers to purchase real estate based on the various inputs (EQ, IR, Pay, Offer, Cash, etc.). In this exemplary embodiment, the monthly payment offer calculation 400 provides up to six offers for six different monthly periods (which can be defined or default values). Those of ordinary skill in the art will recognize that the monthly payment offer calculation 400 can include more or less monthly periods to provide more or less offers.

In FIG. 4, the monthly payment offer calculation 400 starts (step 402) for a Monthsl calculation by retrieving EQ and IR (step 404). EQ is set to EQ1 (step 406) and stored (step 408). A counter is set to 0 (step 410) and stored (step 412). The monthly interest incurred (MonthlyInt1) is calculated by MonthlyInt1=EQ1*IR/2 (step 414) and stored (step 416). The pay amount and MonthlyInt1 are retrieved (step 418). The monthly amount paid to principal (MonthlyPrin1) is calculated as Pay * MonthlyInt1 (step 420) and stored (step 422). The EQ1 and MonthlyPrin1 values are retrieved (step 422). A new EQ1 is calculated as EQ1—MonthlyPrin1 (step 424) and stored (step 426). The counter is incremented by 1 (step 428) and stored (step 430), and the monthly payment offer calculation 400 checks if the counter equals the value of Months1 (step 432). If not, then the monthly payment offer calculation 400 returns to step 414. If so, then the monthly payment offer calculation 400 moves on to a Months2 calculation 500.

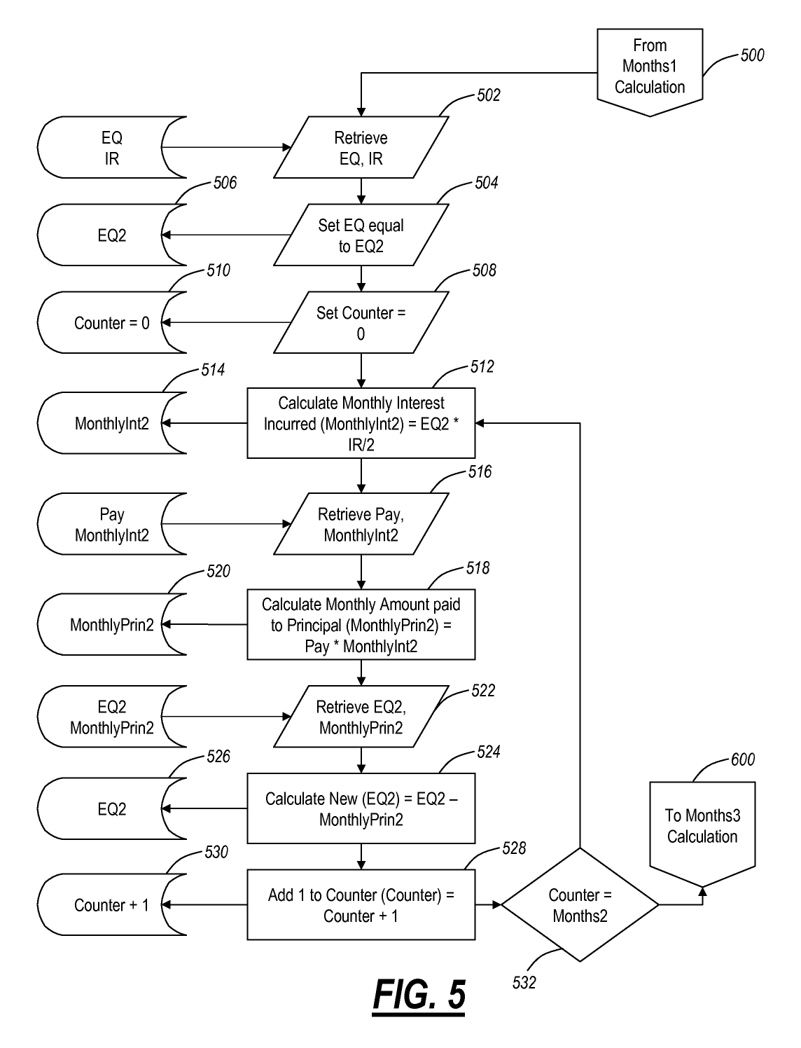

In FIG. 5, the Months2 calculation 500 begins by retrieving EQ and IR (step 502). EQ is set equal to EQ2 (step 504) and stored (step 506). The counter is set equal to 0 (step 508) and stored (step 510). The monthly interest incurred (MonthlyInt2) is calculated by MonthlyInt2=EQ2*IR/2 (step 512) and stored (step 514). The pay amount and MonthlyInt2 are retrieved (step 516). The monthly amount paid to principal (MonthlyPrin2) is calculated as Pay * MonthlyInt2 (step 518) and stored (step 520). The EQ2 and MonthlyPrin2 values are retrieved (step 522). A new EQ2 is calculated as EQ2—MonthlyPrin2 (step 524) and stored (step 526). The counter is incremented by 1 (step 528) and stored (step 530), and the Months2 calculation 500 checks if the counter equals the value of Months2 (step 532). If not, then the Months2 calculation 500 returns to step 512. If so, then the monthly payment offer calculation 400 moves on to a Months3 calculation 600.

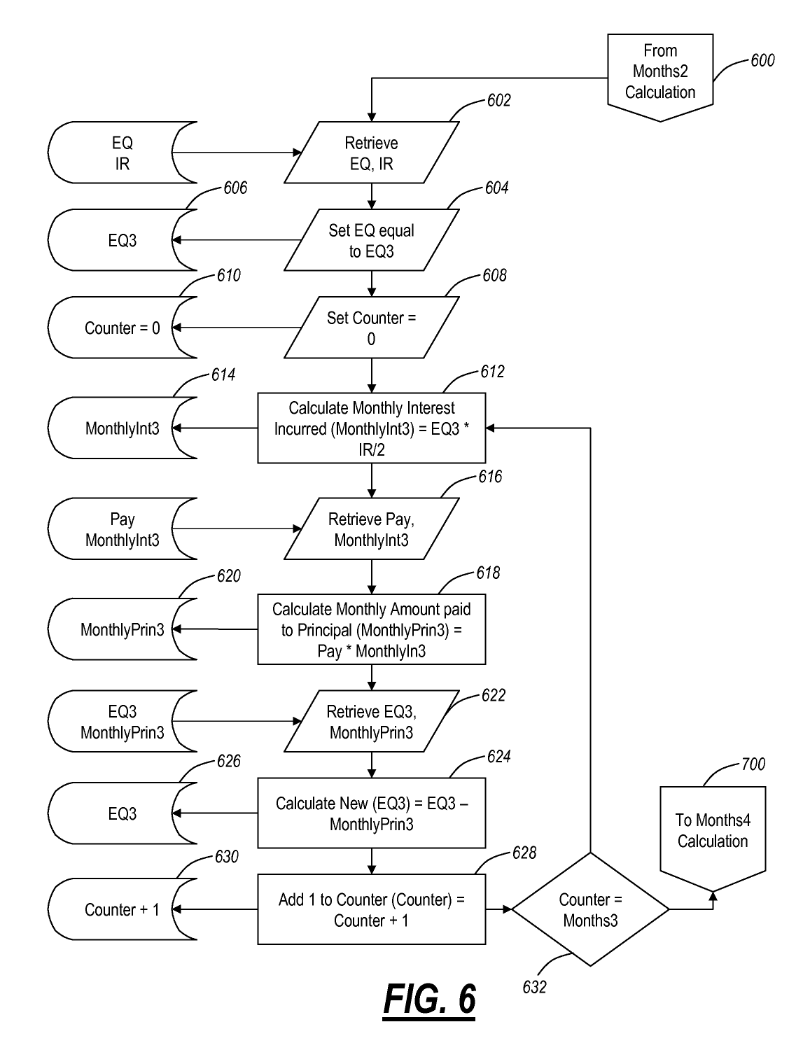

In FIG. 6, the Months3 calculation 600 begins by retrieving EQ and IR (step 602). EQ is set equal to EQ3 (step 604) and stored (step 606). The counter is set equal to 0 (step 608) and stored (step 610). The monthly interest incurred (MonthlyInt3) is calculated by MonthlyInt3=EQ3*IR/2 (step 612) and stored (step 614). The pay amount and MonthlyInt3 are retrieved (step 616). The monthly amount paid to principal (MonthlyPrin3) is calculated as Pay * MonthlyInt3 (step 618) and stored (step 620). The EQ3 and MonthlyPrin3 values are retrieved (step 622). A new EQ3 is calculated as EQ3—MonthlyPrin3 (step 624) and stored (step 626). The counter is incremented by 1 (step 628) and stored (step 630), and the Months3 calculation 600 checks if the counter equals the value of Months3 (step 632). If not, then the Months3 calculation 600 returns to step 612. If so, then the Months3 calculation 600 moves on to a Months4 calculation 700.

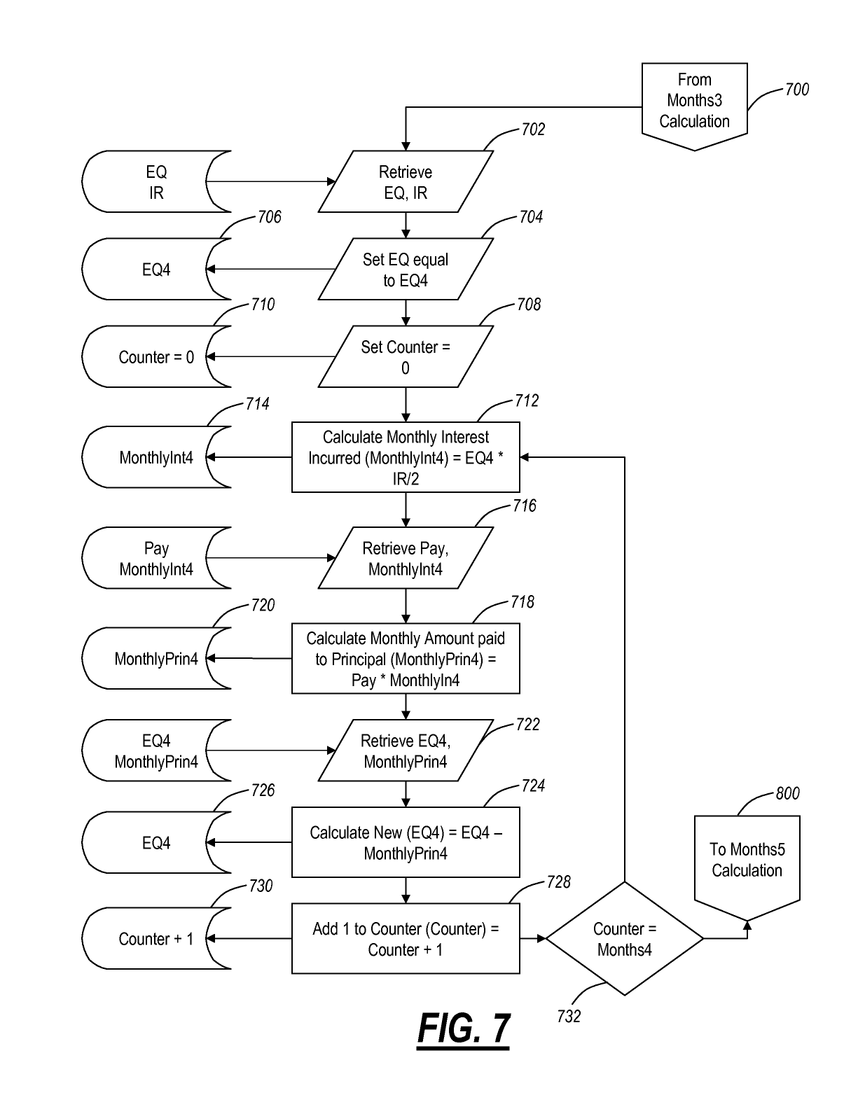

In FIG. 7, the Months4 calculation 700 begins by retrieving EQ and IR (step 702). EQ is set equal to EQ4 (step 704) and stored (step 706). The counter is set equal to 0 (step 708) and stored (step 710). The monthly interest incurred (MonthlyInt4) is calculated by MonthlyInt4=EQ4*IR/2 (step 712) and stored (step 714). The pay amount and MonthlyInt4 are retrieved (step 716). The monthly amount paid to principal (MonthlyPrin4) is calculated as Pay * MonthlyInt4 (step 718) and stored (step 720). The EQ4 and MonthlyPrin4 values are retrieved (step 722). A new EQ4 is calculated as EQ4—MonthlyPrin4 (step 724) and stored (step 726). The counter is incremented by 1 (step 728) and stored (step 730), and the Months4 calculation 700 checks if the counter equals the value of Months4 (step 732). If not, then the Months4 calculation 700 returns to step 712. If so, then the Months4 calculation 700 moves on to a Months5 calculation 800.

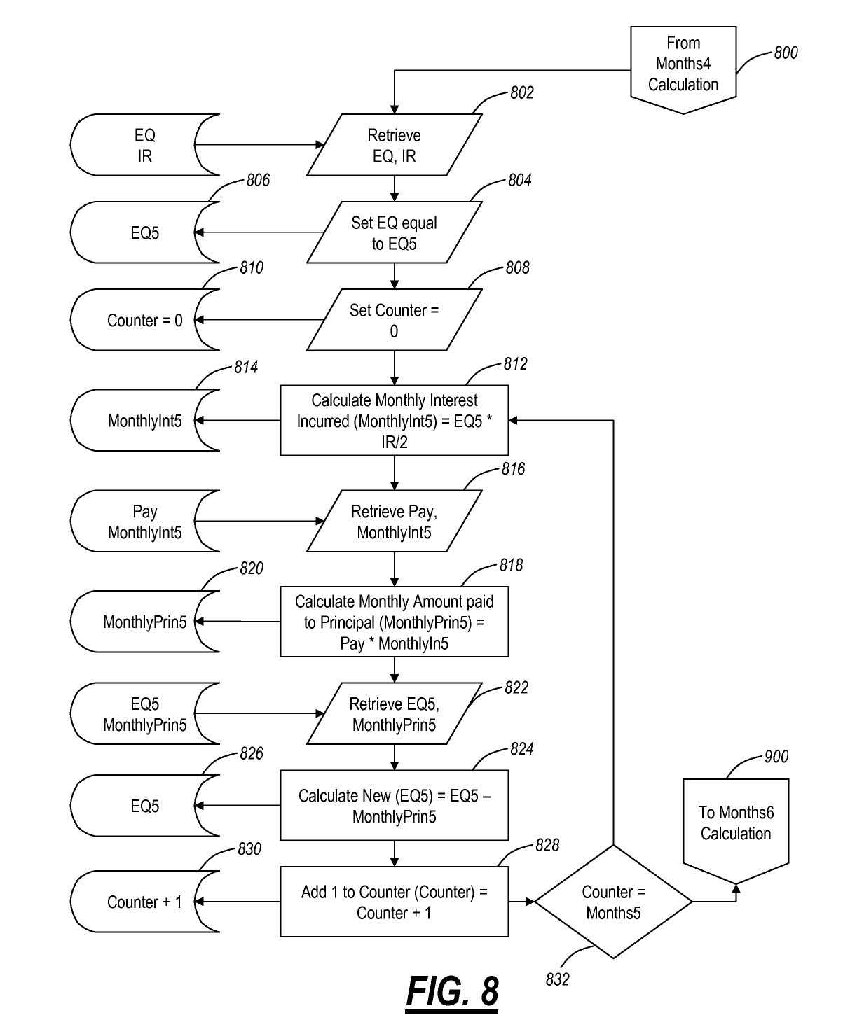

In FIG. 8, the Months5 calculation 800 begins by retrieving EQ and IR (step 802). EQ is set equal to EQ5 (step 804) and stored (step 806). The counter is set equal to 0 (step 808) and stored (step 810). The monthly interest incurred (MonthlyInt5) is calculated by MonthlyInt5=EQ5*IR/2 (step 812) and stored (step 814). The pay amount and MonthlyInt5 are retrieved (step 816). The monthly amount paid to principal (MonthlyPrin5) is calculated as Pay * MonthlyInt5 (step 818) and stored (step 820). The EQ5 and MonthlyPrin5 values are retrieved (step 822). A new EQ5 is calculated as EQ5—MonthlyPrin5 (step 824) and stored (step 826). The counter is incremented by 1 (step 828) and stored (step 830), and the Months5 calculation 800 checks if the counter equals the value of Months5 (step 832). If not, then the Months5 calculation 800 returns to step 812. If so, then the Months5 calculation 800 moves on to a Months6 calculation 900.

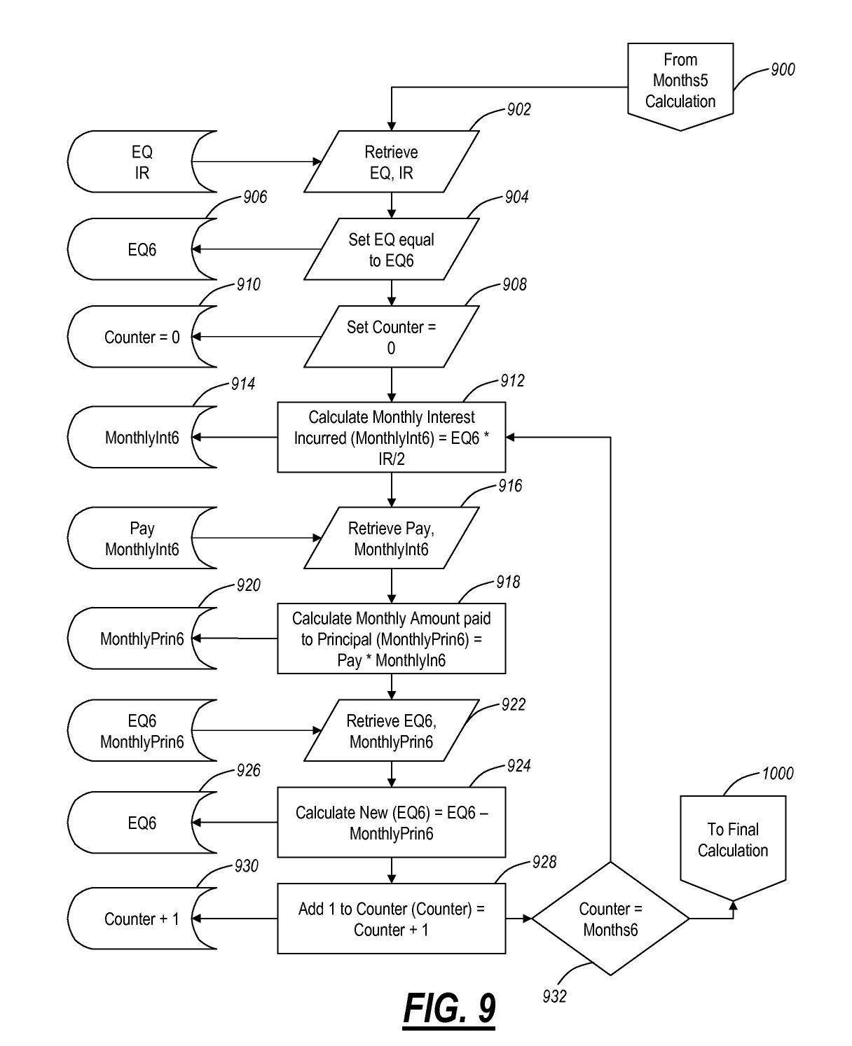

In FIG. 9, the Months6 calculation 900 begins by retrieving EQ and IR (step 902). EQ is set equal to EQ6 (step 904) and stored (step 906). The counter is set equal to 0 (step 908) and stored (step 910). The monthly interest incurred (MonthlyInt6) is calculated by MonthlyInt6=EQ6*IR/2 (step 912) and stored (step 914). The pay amount and MonthlyInt6 are retrieved (step 916). The monthly amount paid to principal (MonthlyPrin6) is calculated as Pay * MonthlyInt6 (step 918) and stored (step 920). The EQ6 and MonthlyPrin6 values are retrieved (step 922). A new EQ6 is calculated as EQ6—MonthlyPrin6 (step 924) and stored (step 926). The counter is incremented by 1 (step 928) and stored (step 930), and the Months6 calculation 900 checks if the counter equals the value of Months6 (step 932). If not, then the Months6 calculation 900 returns to step 912. If so, then the Months6 calculation 900 moves on to a final calculation 1000.

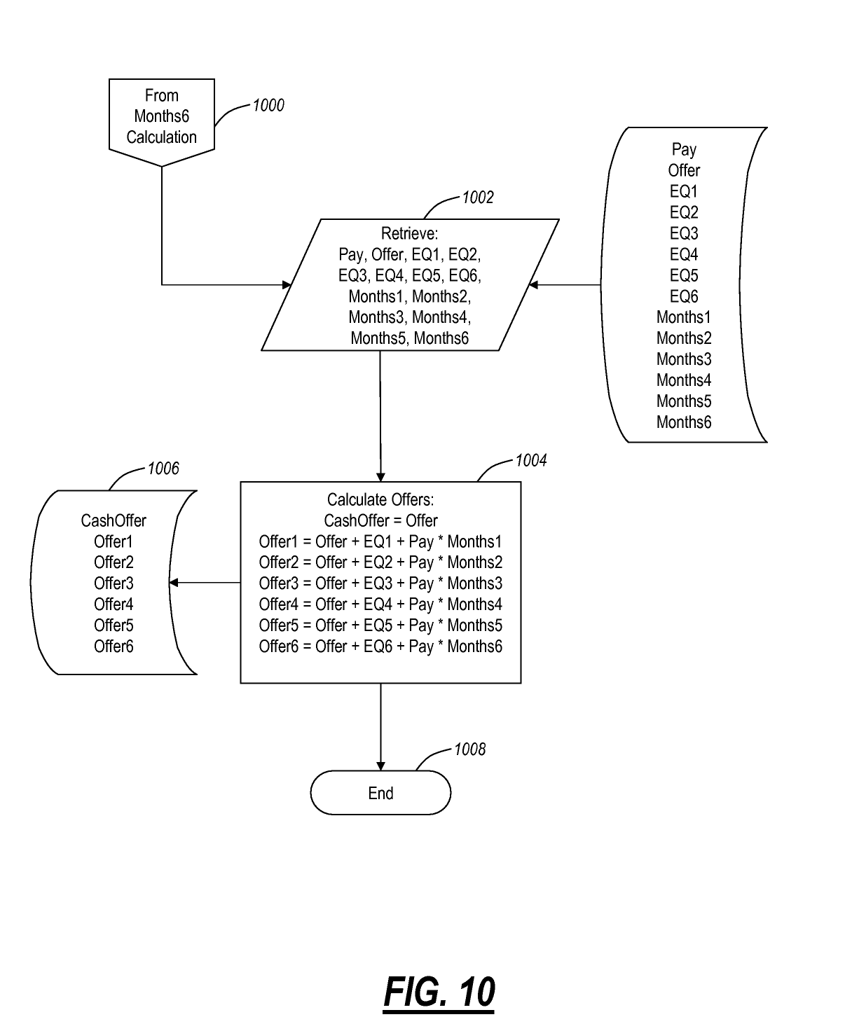

Referring to FIG. 10, a flowchart illustrates the final calculation 1000 of the multiple offers according to an exemplary embodiment of the present invention. The final calculation 1000 first retrieves the various values from FIGS. 2-9 including Pay, Offer, EQ1, EQ2. EQ3, EQ4, EQ5, EQ6, Months1, Months2, Months3, Months4, Months5, Months6, etc. (step 1002). The final calculation 1000 calculates the offers as follows (step 1004):

CashOffer=Offer

Offer1=Offer+EQ1+Pay*Months1

Offer2=Offer+EQ2+Pay*Months2

Offer3=Offer+EQ3+Pay*Months3

Offer4=Offer+EQ4+Pay*Months4

Offer5=Offer+EQ5+Pay*Months5

Offer6=Offer+EQ6+Pay*Months6

These values are stored (step 1006), and the final calculation 1000 ends (step 1008).

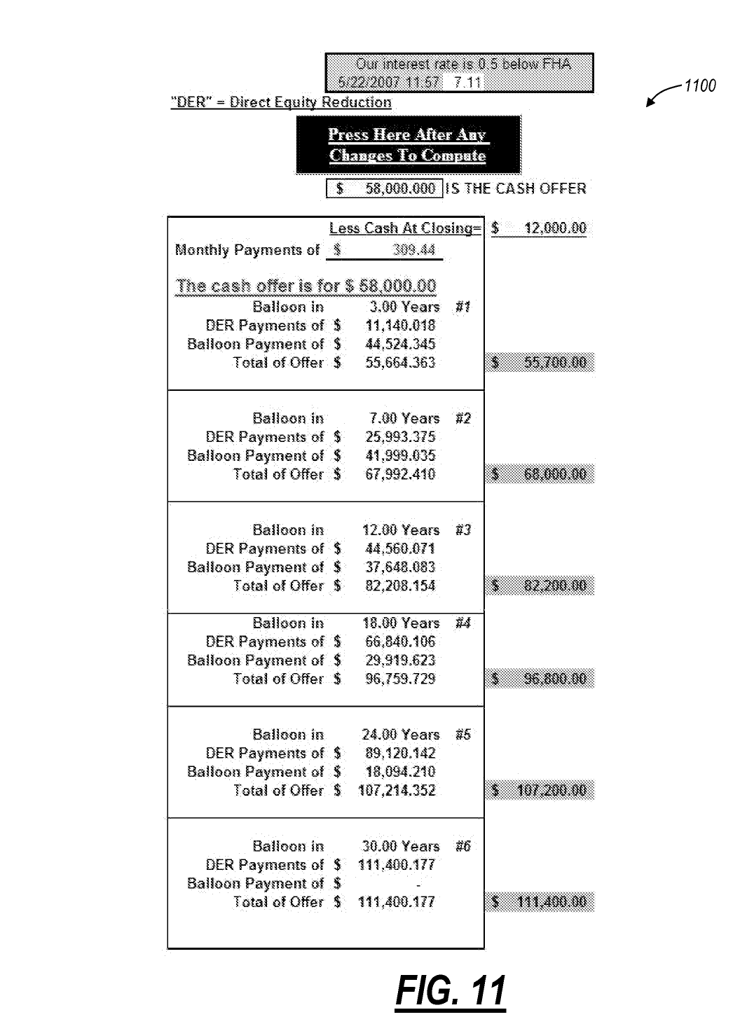

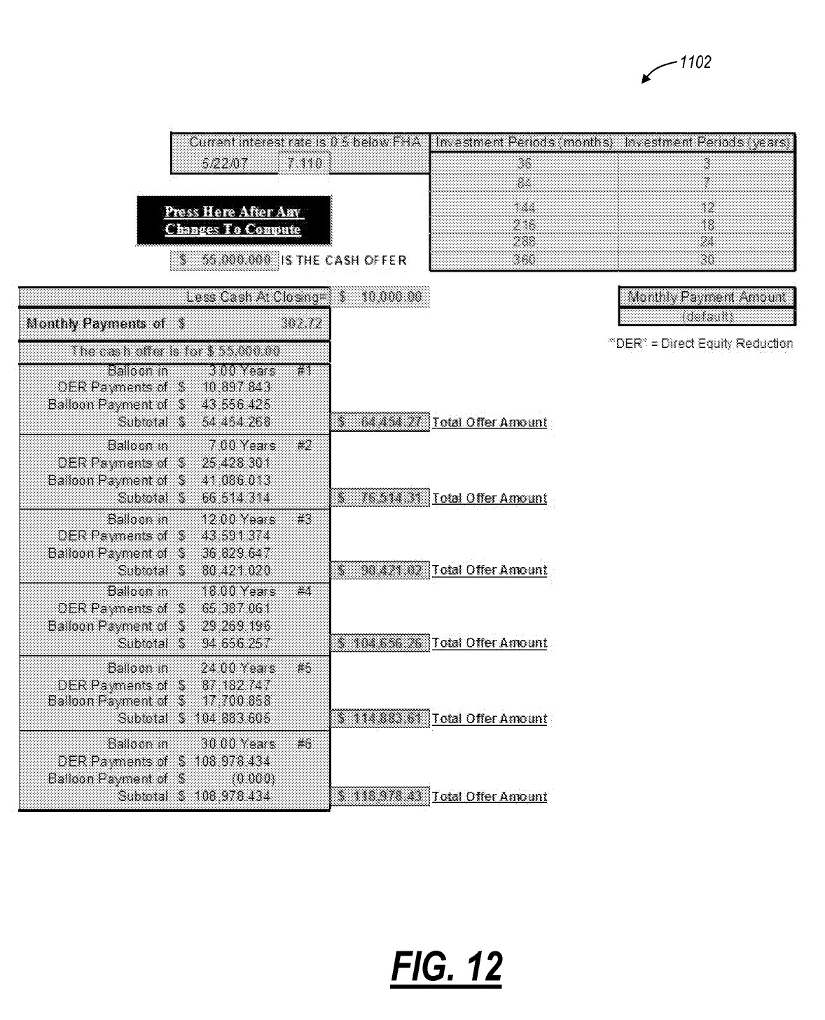

Referring to FIGS. 11 and 12, example screen views 1100, 1102 are illustrated of multiple offer system according to an exemplary embodiment of the present invention. The example screen views 1100, 1102 can include instructions and various input locations to provide variables. For example, the instructions can be to input (1) interest rate, (2) cash offer amount and (3) cash given to seller at closing. Optionally, the user can input (4) monthly payment to be made on seller equity and/or (5 through 10) the time frames for the proposed periods of seller financing.

Press button to calculate and display the “Alternative to All Cash” offers. The resultant display will include for each of six (6) investment periods, the:
Investment Period
Total Offer Amount
Monthly Payment Amount
Balloon Payment Amount
Seller's Original Equity Amount
   At this point, the user can change any of the variables and rerun the calculations.

### Definitions

Investor
Buyer
Seller
   The seller is the root conveyor of the property. For example, if QCHB, LLC negotiated a contract with Joe Bighouse to purchase his property and then acting as a wholesaler, QCHB, LLC then sold the deal to Investor Sally, the seller here is a Mr. Bighouse. The buyer is QCHB, the assignor is QCHB and the assignee is Investor Sally. DER (Direct Equity Reduction) is essentially a 0% loan. The payments made are credited directly to the principle of the loan, thereby directly reducing the seller's equity with each payment on the loan.

When making offers on properties the general rule is that, the more offers written and presented by an investor, the more offers countered or accepted and consequently, the more houses bought and the more money made. Anything that can increase the number of offers that are actually countered or accepted will markedly increase the potential profits for the investor. This is the nuts and bolts of putting together a real estate or other offer for presentation and utilizing multiple approaches to the same offer. The present invention deals with real estate but the approach can be used for any negotiations.

Making multiple offers also allows the presenter of the offer to glean much pertinent information from the owner of the property that may not have been exposed otherwise. Depending upon the response to the offer, the owner can let the presenter know: What else is owed on the property? What other encumbrances are on the property? What real equity do they have in the property? Do they need the cash from the sale now? How much cash do they really need now? Are they going to invest the proceeds of the sale? What rate of return do they expect from those investments? How secure are the anticipated investments? Are subject to tax/capital gains consequences from a cash sale? Would they consider maintaining an equity position for a greater gain? Is there a future event anticipated requiring a lump sum of money?

According to Medvec and Galinsky, utilizing MESOs can: Increase the other side's satisfaction as well as the odds that an agreement will be implemented; Let you collect and integrate complex information, balance aggression with cooperation and persistence with flexibility, and achieve novel outcomes; Even as you aggressively anchor the negotiation in your favor, you are signaling flexibility and managing your reputation; Allow you to explain to your counterpart that there are numerous ways to construct your deal and to ask them which offer works best FOR THEM; If they insist that none of the offers in ideal, you can urge them to indicate which offer best meet their priorities of best accounts for their constraints, clarifying that they are not necessarily choosing one of the offers as a final agreement; Allow you to secure an understanding of the other side's interests that you would be unlikely to ascertain through direct questioning; Glean their priorities and the magnitude of those priorities from their reaction to you offers; Not only promote effective deal making but also allow disputants to reach settlements and avoid impasses and costly litigation; Help you to avoid tiptoeing around the issues, and instead lead the negotiation in a more rewarding direction.

In addition to the example screens 1100, 1102, the MOC1 can include a plurality of modules for whether you have a real estate matter, a technical concern, or if you have a question regarding the calculation system. For example, the MOC1 can include a live help button or the like. There can also include a Q & A section to see if a question has been answered already. For example, buyers/investors can subscribe to the MOC1 and for subscribers who are in the field with no internet access, call up our support center to have us run any numbers that you need remotely.

Advantageously, the MOC1 can provide a win/win solution between buyers and sellers. If the seller says that they need $100,000, the MOC1 helps buyers and sellers by working together to get them close to, or above that figure, instead of angering them by throwing out a figure that's a fraction of what they have in their minds?

The MOC1 can further include systems for doing short sales, rehabs, owner financing, wholesaling, etc. all at once. The MOC1 can include videos on various subjects, e.g., on creating mailing lists, or for a nominal fee, a buyer/investor can send business cards and e-mail accounts to the MOC1. The MOC1 can include training videos, educational content, and a Live Help Desk.

The MOC1 includes Business Intensification Tools that are designed to streamline and automate advertising. These include a virtual powerhouse to bring in the best in e-mail marketing. This allows sending messages, surveys, newsletters, and autoresponders, with the ability to track everything to know when a prospect opened the e-mail, how many times they read it, and if they clicked on any links that you sent.

For example, the MOC1 can give prospects free material and by automatically resending offers that they may have denied. It can include pre-written scripts and even additional templates so that you can set up your campaigns one time and know that your targets are being reached over and over and over.

Additionally, the MOC1 can include a repair estimator which helps walk through a house and know exactly what the repairs will cost? No matter where the house is located, how big or small, how pretty or ugly . . . in three easy steps, the Repair Estimator gives a figure to help determine s best offer, to gauge contractor bids, and to know that you will only have to call an inspector when it's necessary.

The repair estimator includes: Step 1—Do a brief walkthrough of the property or use information given by the seller; Step 2—Check off the things that need repair and about how much work needs to be done; and Step 3—Click the Update button. An investor should only have to determine what the seller needs and to try to get close to, meet, or preferably exceed those needs. So imagine having a seller who does not mind leaving equity in their property, but they are hesitant to close the deal because you are slated to pay them $400 a month, but they have a child going to college in 5 years and they are trying to retire in 12 years. The MOC1 can include with a Customizable Amortization Schedule you can account for all of these things.

Also, what if you need to make smaller payments with 0% interest for the first few months to get some repairs done or to find a tenant? Just put those figures in the calculator and everything is readjusted for you. Advantageously, this saves costs by avoiding paying attorneys hundreds of dollars for amortization schedules that do not even account for these changes because they are major leverage points and they will make the numbers fit both of your needs.

Just make any necessary changes and print the page. There are an abundance of templates on the site for websites and e-mails, but the present invention takes marketing a step further by providing pre-written campaigns tailored for realtors, prospects, other investors, and more. All a user has to do is cut and paste these scripts into e-mails, edit to the user's liking, then set it and forget it.

A Maximum Allowable Calculator gives a user the bottom line, instantly. Just input the home's estimated resale value (or ARV—After Repair Value) and hit the update button. If a user cannot determine the after repair value, just input what the seller feels the house is worth. If they will take your MAO based on this figure and the ARV turns out to be lower than expected, they will more than likely work with you to readjust the price rather than attempt to put the house back on the market. Also, your addendums will cover you should the house prove insufficient upon further inspection.

Typically MAO is calculated as 70% of the ARV minus repairs. On average, properties take around three to six months to sale when priced correctly. Today that figure is more like six to nine months. Therefore, the MOC1 keeps the percentage area in our calculator open so that you can adjust this rate accordingly.

Also, the MOC1 can include a Distributable eBook Center. This area gives a user a multitude of various eBooks for building campaigns on and e-mail to clients. Picture opening your e-mail and seeing a message that says “Thought you'd like this free eBook after the holidays get underway!” and inside is an eBook on exercising. Your tag line? “Call me about your house so that we can see what we can Work Out.” Use this in conjunction with our marketing system to send beautiful holiday and seasonal e-mails, birthday e-mails, and professional notes. Some of the eBooks are serious, some are fun, but no matter what, they are all free gifts that will keep you in your recipient's minds.

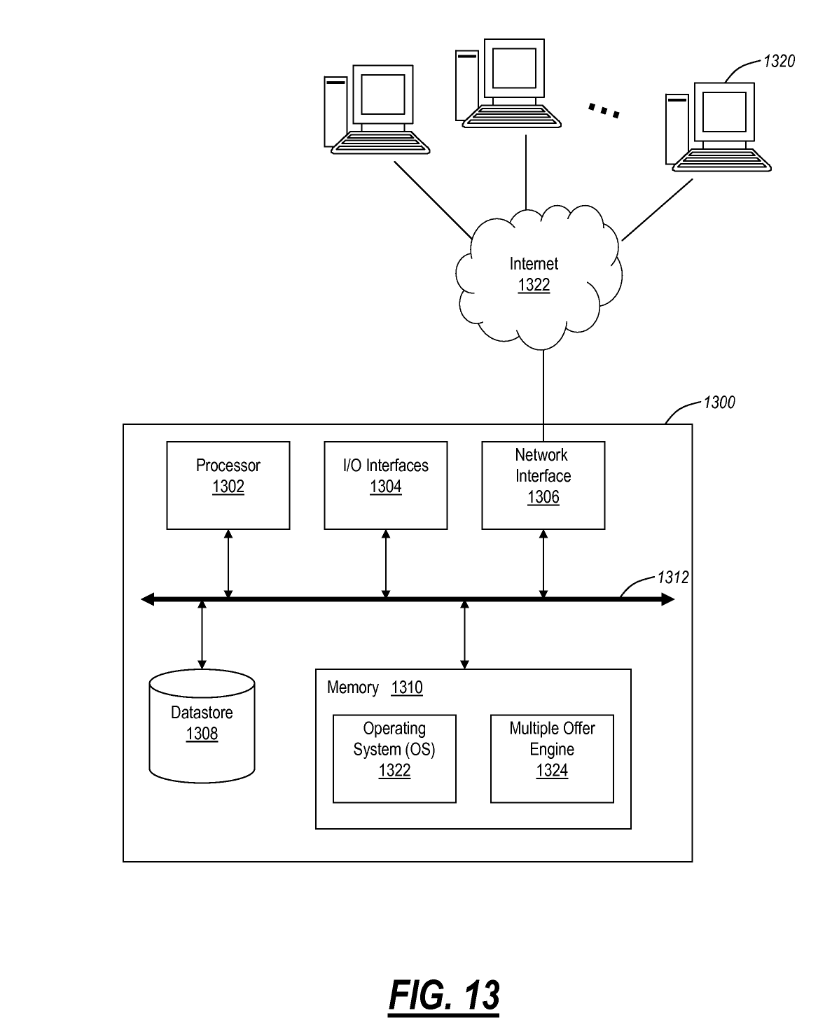

Referring to FIG. 13, a block diagram illustrates a server 1300 for executing a multiple offer system according to an exemplary embodiment of the present invention. The server 1300 can be a digital computer that, in terms of hardware architecture, generally includes a processor 1302, input/output (I/O) interfaces 1304, network interfaces 1306, memory 1310, and a data store 1308. The components (1302-1310) are communicatively coupled via a local interface 1312. The local interface 1312can be, for example but not limited to, one or more buses or other wired or wireless connections, as is known in the art. The local interface 1312can have additional elements, which are omitted for simplicity, such as controllers, buffers (caches), drivers, repeaters, and receivers, among many others, to enable communications. Further, the local interface 1312can include address, control, and/or data connections to enable appropriate communications among the aforementioned components.

The processor 1302 is a hardware device for executing software instructions. The processor 1302 can be any custom made or commercially available processor, a central processing unit (CPU), an auxiliary processor among several processors associated with the server 1300, a semiconductor-based microprocessor (in the form of a microchip or chip set), or generally any device for executing software instructions. When the server 1300 is in operation, the processor 1302 is configured to execute software stored within the memory 1310, to communicate data to and from the memory 1310, and to generally control operations of the server 1300 pursuant to the software instructions.

The I/O interfaces 1304 can be used to receive user input from and/or for providing system output to one or more devices or components. User input can be provided via, for example, a keyboard and/or a mouse. System output can be provided via a display device and a printer (not shown). I/O interfaces can include, for example, a serial port, a parallel port, a small computer system interface (SCSI), an infrared (IR) interface, a radio frequency (RF) interface, and/or a universal serial bus (USB) interface.

The network interfaces 1306 can be used to enable the server 1300 to communicate on a network. For example, the server 1300 can utilize the network interfaces 1306 to communicate to a plurality of users 1320 over the Internet 1322 or some other network. The network interfaces 1306 can include, for example, an Ethernet card (e.g., 10BaseT, Fast Ethernet, Gigabit Ethernet) or a wireless local area network (WLAN) card (e.g., 802.11a/b/g). The network interfaces 1306 can include address, control, and/or data connections to enable appropriate communications on the network.

A data store 1308 can be used to store data, such as variables and other data for the MOC1. The data store 1308 can include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 1308 can incorporate electronic, magnetic, optical, and/or other types of storage media. In one example, the data store 1308 can be located internal to the server 1300 such as, for example, an internal hard drive connected to the local interface 1312 in the server 1300. Additionally in another embodiment, the data store can be located external to the server 1300 such as, for example, an external hard drive connected to the I/O interfaces 1304 (e.g., SCSI or USB connection). Finally in a third embodiment, the data store may be connected to the server 1300 through a network, such as, for example, a network attached file server.

The memory 1310 can include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 1310 may incorporate electronic, magnetic, optical, and/or other types of storage media. Note that the memory 1310 can have a distributed architecture, where various components are situated remotely from one another, but can be accessed by the processor 1302.

The software in memory 1310 can include one or more software programs, each of which includes an ordered listing of executable instructions for implementing logical functions. In the example of FIG. 13, the software in the memory system 70 includes a suitable operating system (O/S) 1322 and a multiple offer engine 1324. The operating system 1322 essentially controls the execution of other computer programs, such as the multiple offer engine 1324, and provides scheduling, input-output control, file and data management, memory management, and communication control and related services. The operating system 1322 can be any of Windows NT, Windows 2000, Windows XP, Windows Vista (all available from Microsoft, Corp. of Redmond, Wash.), Solaris (available from Sun Microsystems, Inc. of Palo Alto, Calif.), or LINUX (or another UNIX variant) (available from Red Hat of Raleigh, N.C.).

The multiple offer engine 1324 is configured to perform the various mechanisms described herein. Additionally, the present invention contemplates a stand alone programs (i.e., no need for a network interface 1306) and a mobile-based (cell-phone, PDA, etc.). The multiple offer engine 1324 can be implemented as a Web page with secure access to the various tools. For example, the multiple offer engine 1324 can be geared towards RE investor but the MOC1 system, forms and other tools can be offered separately for those who don't feel a need to subscribe to the entire site's benefits.

The multiple offer engine 1324 can include a MOC1 Offer Negotiating System marketing page will have separate pages for realtors vs. investors, a MOC1 Forms System marketing page will have separate pages for realtors vs. investors., a MOC1 Mortgage Short Sale System marketing page will have separate pages for realtors vs. investors, and a MOC1 Auto Watch & Re-submittal marketing page will have separate pages for realtors vs. investors.

There can be a separate page where all other guru's products will be for sale with a brief description of each product. There will also be a link from the product to a more detailed description and then either back or to the shopping cart page. If a browser leaves the marketing page, there will an offer to use all of the products for 30 days and only pay at the end if you like it. Upon completing the purchase, there will be numerous offers to buy other products. There can be a page where they access the MOC1 calculator for use. There can be a page to access the many forms we'll have available for use.

The multiple offer engine 1324 can include security such as: 1. Spread sheets with log on password; 2. Stand alone application with password loading; 3. Stand alone application that requires the disk to be inserted to run; 4. Stand alone application that requires a disk that can't be copied to be inserted to run; 5. Stand alone application that must periodically be authorized over the net to continue running; 6. Stand alone application that must run from the same computer or be reauthorized over the net; 7. Stand alone application that requires a dongle in a USB or other port to run; 8. The application will be programmed in JAVA and run over the internet only and the front end (visible over the net) will only display the results of the calculations, while the back end (not accessible over the net) will have all of the programming; and 9. In addition to requiring a password in #8, the application and log in can only be done from one or two computers without requiring additional keys for access.

Additionally, the multiple offer engine 1324 can include a link to a page that shows the current prime, FHA and other interest rates an investor may need to appraise the current market. Also short and long term graphs of each. The interest rate (IR) is determined and entered into the program where indicated. This interest rate is the effective rate that the buyer-investor pays for the use of the money that the seller-investor leaves in the property for some term. The suggested rate is 0.5% below the current FHA rate. This rate is considerably more than the bank gives on savings deposits but much less than credit card, investor loan and hard money lender rates.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A computer-executable method for providing multiple offers from a buyer to a seller, comprising:
determining a maximum allowable offer;
determining an interest rate;
determining a plurality of time periods;
calculating multiple offers based on the plurality of time periods from the maximum allowable offer, the interest rate; and
displaying the multiple offers.

2. The computer-executable method of claim 1, further comprising:
determining whether the seller owes more than the maximum allowable offer for a property or substantially the same as the maximum allowable offer;
if the seller owes more than the maximum allowable offer, performing one of watching the property and performing a short sale on the property; and
if the seller owes substantially the same as the maximum allowable offer, taking over the property from the seller.

3. The computer-executable method of claim 1, wherein the calculating multiple offers comprises:
performing one of calculating a monthly payment calculation and inputting a monthly payment to the seller; and
calculating seller retained equity as a difference of the maximum allowable offer and a cash offer amount.

4. The computer-executable method of claim 3, wherein the calculating a monthly payment calculation comprises:
computing the monthly payment from sellers retained equity and the interest rate over a predetermined time period.

5. The computer-executable method of claim 1, wherein the multiple offers comprise any of a cash offer and a payment plan over the plurality of time periods with a balloon payment.

6. The computer-executable method of claim 1, wherein the computer-executable method is executed on a computer server connected to a network.

7. The computer-executable method of claim 1, wherein the computer-executable method is executed as a stand-alone program on one of a computer system, a cell phone, and a personal digital assistant.

8. A system for computing multiple offers from a buyer to a seller, comprising:
a data store;
memory;
a network interface connected to a network;
input/output interfaces;
a processor;
a local interface communicatively coupling the data store, the memory, the network interface, the input/output interfaces, and the processor;
wherein the processor is configured to perform the steps of:
determining a maximum allowable offer;
determining an interest rate;
determining a plurality of time periods;
calculating multiple offers based on the plurality of time periods from the maximum allowable offer, the interest rate; and
displaying the multiple offers.

9. The system of claim 8, wherein the processor is configured to perform the steps of:
determining whether the seller owes more than the maximum allowable offer for a property or substantially the same as the maximum allowable offer;
if the seller owes more than the maximum allowable offer, performing one of watching the property and performing a short sale on the property; and
if the seller owes substantially the same as the maximum allowable offer, taking over the property from the seller.

10. The system of claim 8, wherein the processor is configured to perform the steps of:
performing one of calculating a monthly payment calculation and inputting a monthly payment to the seller; and
calculating seller retained equity as a difference of the maximum allowable offer and a cash offer amount.

11. The system of claim 10, wherein the processor is configured to perform the steps of:
computing the monthly payment from sellers retained equity and the interest rate over a predetermined time period.

12. The system of claim 8, wherein the multiple offers comprise any of a cash offer and a payment plan over the plurality of time periods with a balloon payment.

13. A computer system, comprising:
means for receiving input and providing output to a plurality of users comprising buyers and sellers;
means for calculating multiple offers for a purchase from a buyer to a seller;
means for customizing the multiple offers based of a plurality of variables;
an Offer Negotiating System;
a Forms System;
a Mortgage Short Sale System; and
an Auto Watch and Re-submittal marketing page.

14. The computer system of claim 13, further comprising means for displaying real estate.
